(19) United States
(12) Patent Application Publication
(10) Pub. No.: US 2013/0293360 A1
(43) Pub. Date: Nov. 7, 2013

(54) All new Ui-E1-Stroke operation control devices

(71) Applicant: Shuen-Fu Lo, Dapi Township (TW)

(72) Inventor: Shuen-Fu Lo, Dapi Township (TW)

(21) Appl. No.: 13/694,197

(22) Filed: Nov. 6, 2012

(30) Foreign Application Priority Data
May 2, 2012 (TW) 101208212

(51) Int. Cl. G08C 19/16

(52) U.S. Cl. CPC G08C 19/16
USPC 340/12.22

(57) ABSTRACT

The invention is an all new Ui-E1-Stroke operation and control device, which consists of trajectory input and trajectory recognition subsystem. Specifically, users may use their hands to directly engage in operation and control. A single person could use both hands, while multiple persons could each use a single hand to operate and control. Therefore, the invention facilitates an easy-to-learn and easy-to-use operation and control which does not rely on any traditional tool such as a remote controller. Ui-E1-Stroke devices provide comma-shaped and arc-shaped trajectory input and recognition, and even are able to provide reverse manipulation. In summary, most users will have an all new easy operation and control.

### FIELD OF THE INVENTION

The invention is an all new Ui-E1-Stroke operation and control device, which consists of trajectory input and trajectory recognition subsystem. Specifically, users may use their hands to directly engage in operation and control. A single person could use both hands, while multiple persons could each use a single hand to operate and control. Therefore, the invention facilitates an easy-to-learn and easy-to-use operation and control which does not rely on any traditional tool such as a remote controller.

### BACKGROUND

Nowadays, the traditional remote controllers are the most commonly used operation and control devices. However, the specific operation requirements and/or control functions of these remote controllers dictate their drastically different designs with different sizes and capabilities, which result in a wide variety of issues such as the lack of specific function key(s) on certain remote controllers. FIG. 1 depicts a traditional remote controller after simplify. As shown, the individual function keys are independent and unrelated and their usage is not intuitive. A user needs to comprehend detailed operational manuals for their correct usage.

### SUMMARY OF THE INVENTION

In order to overcome the aforementioned traditional tool such as: a remote controller, etc., resulting in a pile of large and small troubled issues. The invention is an all new Ui-E1-Stroke operation and control device, which consists of trajectory input and trajectory recognition subsystem. Specifically, users may use their hands to directly engage in operation and control. A single person could use both hands, while multiple persons could each use a single hand to operate and control. Therefore, the invention facilitates an easy-to-learn and easy-to-use operation and control. Ui-E1-Stroke devices provide comma-shaped and arc-shaped trajectory input and recognition, and even are able to provide reverse manipulation. In summary, most users will have an all new easy operation and control.

This operation control device may be used to operate and control computer and home appliances, including TV set, air conditioner, microwave ovens, induction cooker, water heater, etc.

### BRIEF DESCRIPTIONS OF THE DRAWINGS

FIG. 1 depicts the appearance of a schematic diagram for a conventional traditional remote controller where the keys are individual.

FIG. 2 depicts a configuration diagram of the embodiment for the invention device, which consists of Ui-E1-Stroke trajectory input and trajectory recognition subsystem.

FIG. 3 depicts a configuration diagram of another embodiment similar to FIG. 2 for the invention device.

FIG. 4 depicts a configuration diagram of the repetitive operation and control embodiment for the invention device.

FIG. 5 depicts a configuration diagram of another embodiment similar to FIG. 4 for the invention device.

FIG. 6 depicts a configuration diagram of another group operation and control embodiment for the invention device.

FIG. 7 depicts a configuration diagram of another embodiment similar to FIG. 6 for the invention device.

FIG. 8 depicts a configuration diagram of next group directly operation and control embodiment for the invention device.

FIG. 9 depicts a configuration diagram of another embodiment similar to FIG. 8 for the invention device.

FIG. 10 depicts a configuration diagram of the reversal operation and control embodiment for the invention device.

FIG. 11 depicts a configuration diagram of another embodiment similar to FIG. 10 for the invention device.

FIG. 12 depicts a configuration diagram of the complex operation and control embodiment for the invention device.

FIG. 13 depicts a configuration diagram of another supplementary complex embodiment similar to FIG. 12 for the invention device.

FIG. 14 depicts a configuration diagram of the left-handed versus right-handed embodiment for the invention device.

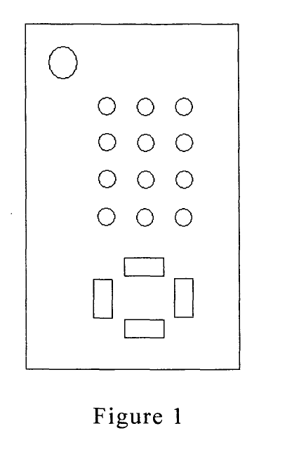

The invention is described via the following embodiment examples and accompanying figures, and to get a full understanding and embodiment for implementing:

### DETAILED DESCRIPTIONS OF THE INVENTION

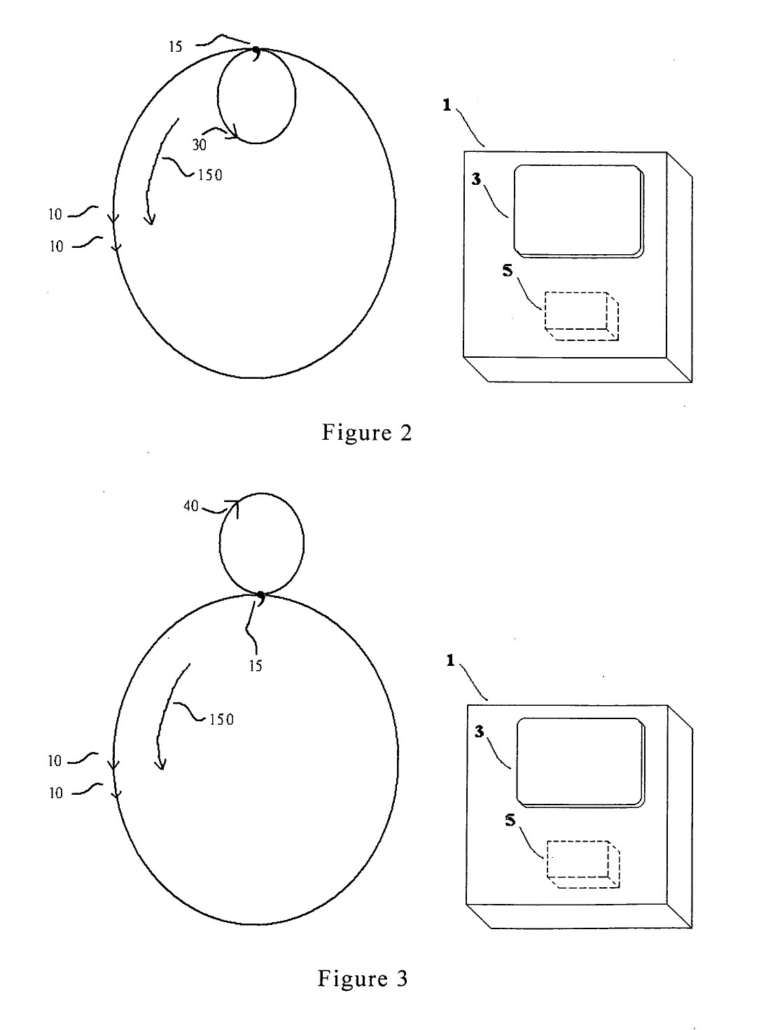

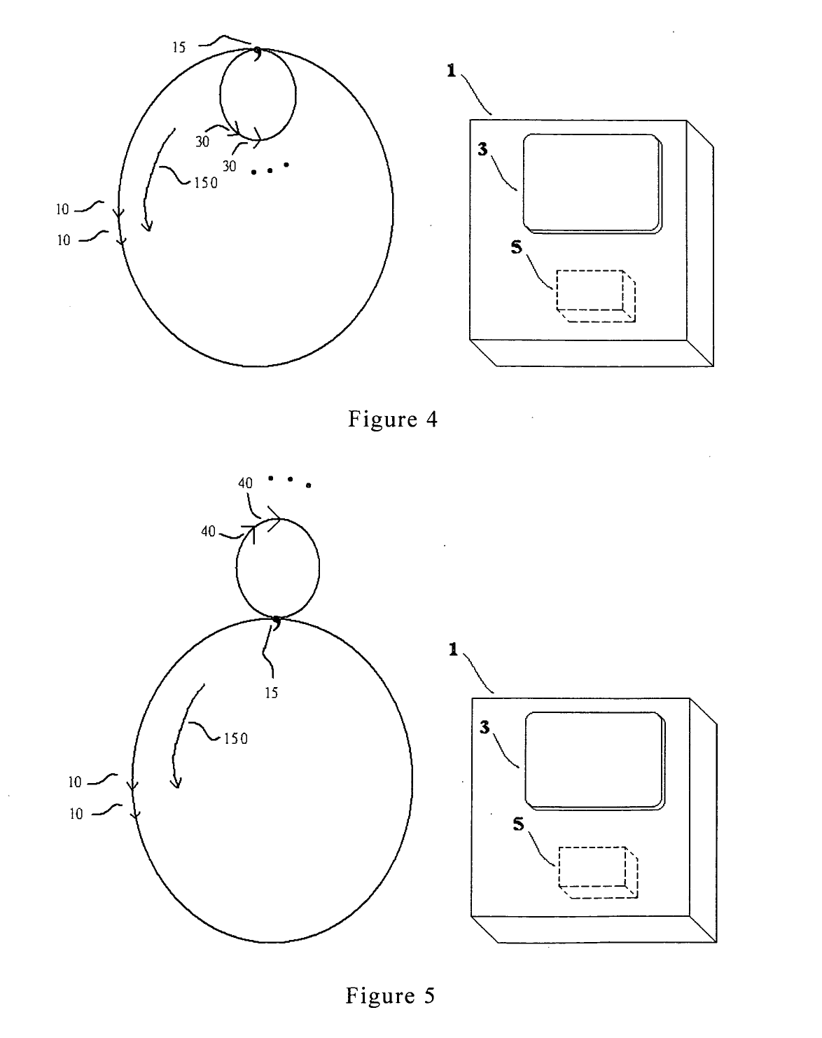

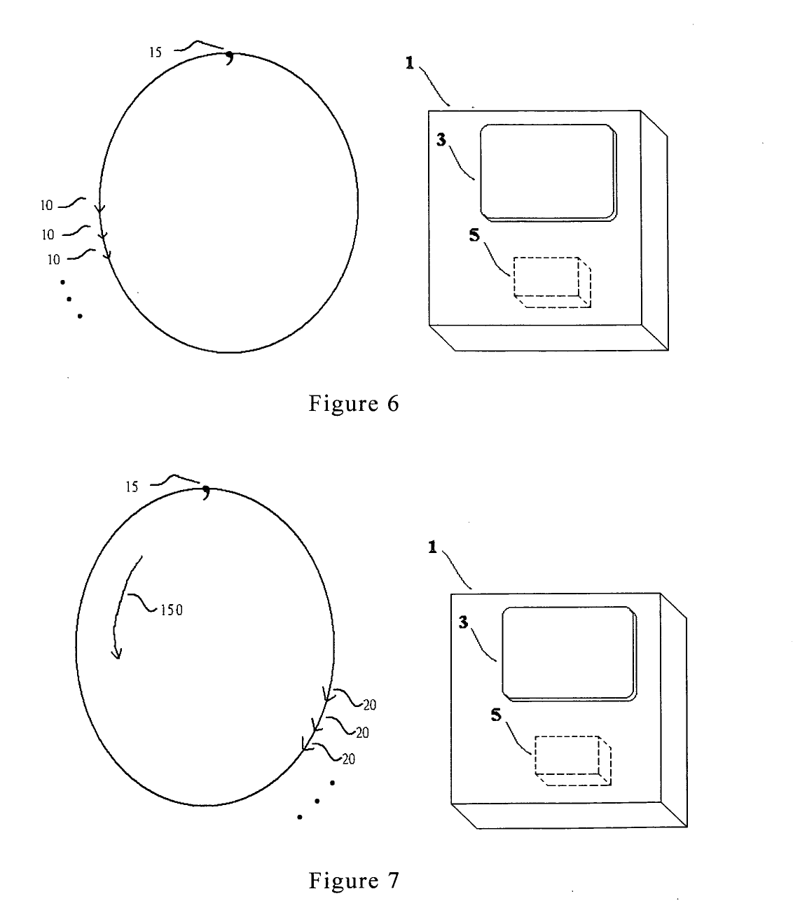

Referring to FIG. 2, The invention is an all new Ui-E1-Stroke operation and control device (1), which consists of trajectory input subsystem (3) and the trajectory recognition subsystem (5). Especially, users may use their hands to directly engage in operation and control. A single person could use both hands, while multiple persons could each use a single hand to operate and control. Therefore, the invention facilitates an easy-to-learn and easy-to-use operation and control. The user will complete the trajectories that FIG. 2 shows. First, the user completes the first large counter-clockwise trajectory (10), and then the second large counter-clockwise trajectory (10). These two trajectories are repeated. Then, the user completes one comma-shaped trajectory (15) and one counter-clockwise arc-shaped trajectory (150). Finally, the user must complete one small counter-clockwise trajectory (30).

Referring to FIG. 3, the user will complete the trajectories that FIG. 3 shows. First, the user completes the first large counter-clockwise trajectory (10), and then the second large counter-clockwise trajectory (10). These two trajectories are repeated. Then, the user completes one comma-shaped trajectory (15) and one counter-clockwise arc-shaped trajectory (150). Finally, the user must complete one small counter-clockwise trajectory (30).

The invention will result in the following operation and control:

1. Trajectories shown in FIG. 2 represent one kind of operation and control manipulation, for example, turning ON (ON/OFF) , while trajectories shown in FIG. 3 represent the other kind of operation and control manipulation, for example, turning OFF (ON/OFF). These are simple manipulations, and again cite other manipulation, such as the following description.

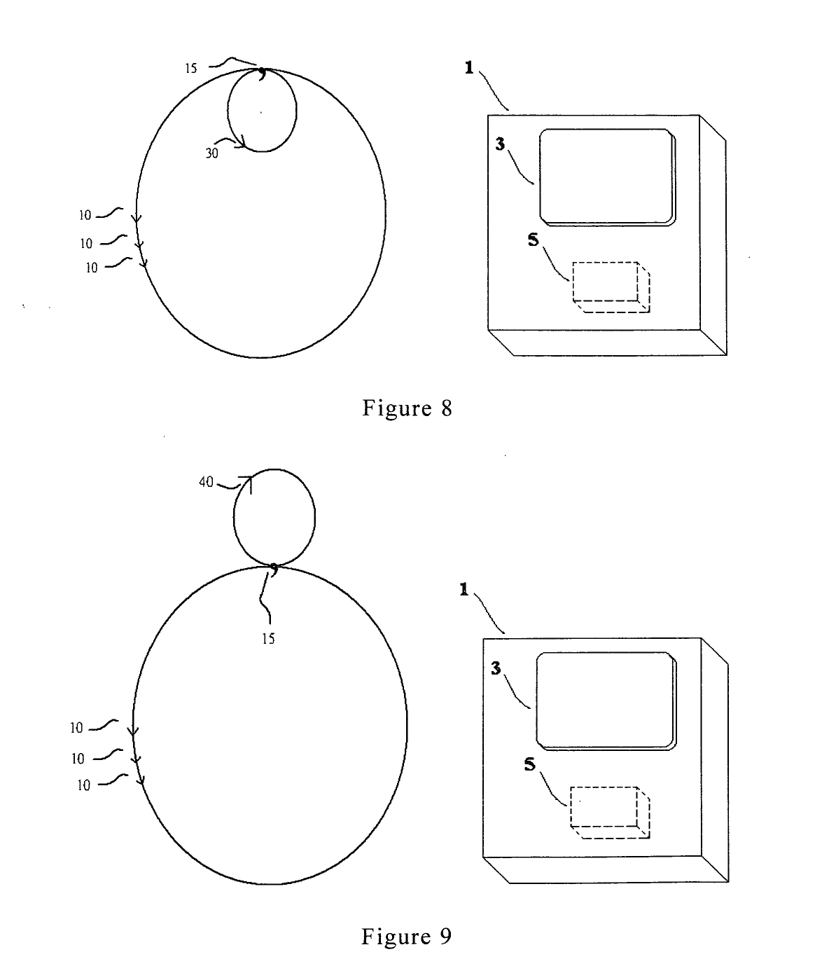

2. Follow the above descriptions. Trajectories shown in FIG. 8 represent one kind of operation and control manipulation, for example, increasing volume, while trajectories shown in FIG. 9 represent the other kind of operation and control manipulation, for example, decreasing volume.

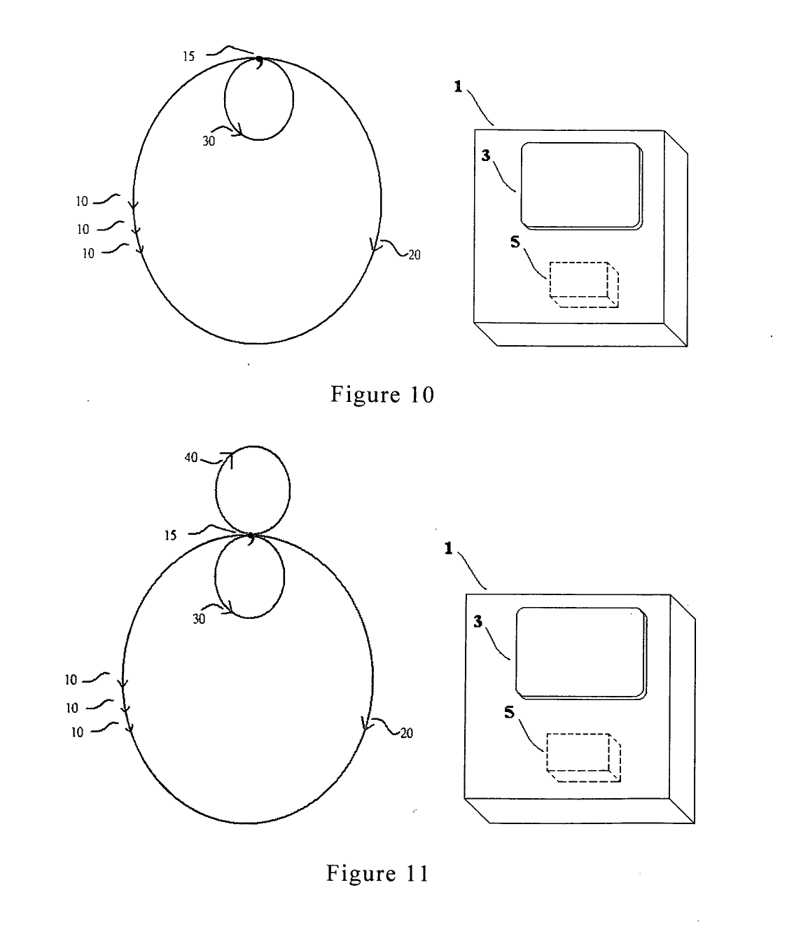

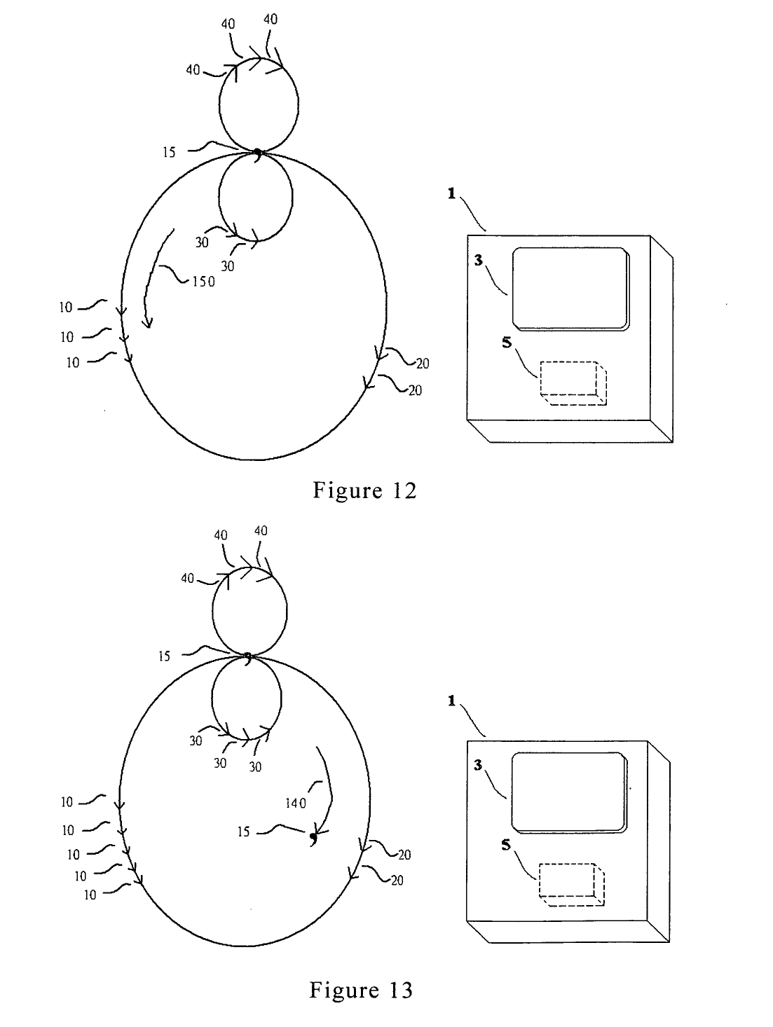

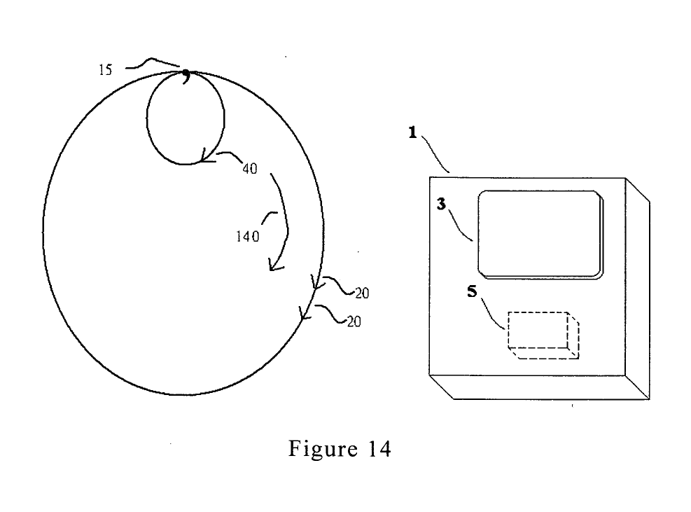

Thus, based on the above descriptions and the accompanying figures, Ui-E1-Stroke devices provide comma-shaped and arc-shaped trajectory input and recognition, and even are able to provide reverse manipulation, such as shown in FIG. 10, etc. In summary, most users will have an all new easy operation and control.

This operation and control device: (1) Ui-E1-Stroke device, (3) Ui-E1-Stroke trajectory input subsystem, (5) Ui-E1-Stroke trajectory recognition subsystem, (10) Large counter-clockwise trajectory, (15) Comma-shaped trajectory, (20) Large clockwise trajectory, (30) Small counter-clockwise trajectory, (40) Small clockwise trajectory, (140) Clockwise arc-shaped trajectory, (150) Counter-clockwise arc-shaped trajectory, and wherein (10) and (20) are reversal manipulations to each other; and (30) and (40) are reversal manipulations to each other; and (140) and (150) are reversal manipulations to each other. These trajectories may be used to operate and control computers and home appliances, including TV set, air conditioner, microwave ovens, induction cooker, water heater, etc.

1. An all new Ui-E1-Stroke operation control device, which consists of trajectory input and trajectory recognition subsystem. The combination of the device is that trajectory input subsystem is outer, while the trajectory recognition subsystem is inside. A single person could use both hands, while multiple persons could each use a single hand, via the input as well as the recognition to be providing the function with reverse operation and control nature. The Ui-E1-Stroke trajectories include two repetitive large trajectories, comma-shaped trajectories, arc-shaped trajectories, and plus at least one individual trajectory.

2. The device of claim 1, via the input as well as the recognition to be providing the function with reverse operation and control nature, wherein the plus trajectory is a small trajectory inside the large trajectory.

3. The device of claim 1, via the input as well as the recognition to be providing the function with reverse operation and control nature, wherein the plus trajectory is a small trajectory outside the large trajectory.

4. The device of claim 1, via the input as well as the recognition to be providing the function with reverse operation and control nature, wherein the plus trajectory is a large and repetitive trajectory.

5. The device of claim 1, via the input as well as the recognition to be providing the function with reverse operation and control nature, wherein the plus trajectories are:
a large and reversal trajectory;
an individual arc-shaped trajectory.

6. The device of claim 1, via the input as well as the recognition to be providing the function with reverse operation and control nature, wherein the plus trajectories are:
a large and repetitive trajectory;
a small trajectory inside the large trajectory.

7. The device of claim 1, via the input as well as the recognition to be providing the function with reverse operation and control nature, wherein the plus trajectories are:
a large and repetitive trajectory;
a small trajectory outside the large trajectory.

8. The device of claim 1, via the input as well as the recognition to be providing the function with reverse operation and control nature, wherein the plus trajectories are:
a large and repetitive trajectory;
a large and reversal trajectory;
a small trajectory inside the large trajectory.

9. The device of claim 1, via the input as well as the recognition to be providing the function with reverse operation and control nature, wherein the plus trajectories are:
a large and repetitive trajectory;
a large and reversal trajectory;
a small trajectory outside the large trajectory.

10. The device of claim 1, via the input as well as the recognition to be providing the function with reverse operation and control nature, wherein the plus trajectories are:
a large and repetitive trajectory;
a large and reversal trajectory;
a small trajectory;
a small and reversal trajectory.
